(19) United States
(12) Patent Application Publication
(10) Pub. No.: US 2006/0187770 A1
(43) Pub. Date: Aug. 24, 2006

(54) Method and system for playing audio at a decelerated rate using multiresolution analysis technique keeping pitch constant

(75) Inventor: Manoj Kumar Singhal, Bangalore (IN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 11/063,859

(22) Filed: Feb. 23, 2005

(51) Int. Cl. G11B 21/08

(52) U.S. Cl. 369/30.01

(57) ABSTRACT

A signal processing unit for playing back an audio signal at a decelerated rate keeping pitch constant. The audio signal is at least one of a speech signal, a pure music or an audio signal which comprises of both speech and music signal. The signal processing unit comprises a plurality of bandpass filters with each of them receiving a first plurality of samples of the audio signal, a plurality of interpolators and an adder. The plurality of bandpass filters generate a second set of plurality of samples after passing the first plurality of samples of the audio signal through each of them. The plurality of bandpass filters have different pass bands, different stop bands, and a constant Q factor. The plurality of interpolators are connected to the plurality of bandpass filters and generate a third set of plurality of samples. The plurality of bandpass filters and the plurality of interpolators correspond in number. The adder superimposes constituents of the third set of plurality of samples generated by the plurality of interpolators. The adder outputs a fourth plurality of samples which on playing gives rise to a decelerated version of the audio signal having a pitch which is consistent with a pitch of the audio signal in a non-decelerated condition.

### BACKGROUND OF THE INVENTION

1. Field of the Invention

The present invention relates to a method and apparatus for playing back an audio signal at a decelerated rate by a signal processing unit and simultaneously keeping pitch of the audio signal constant using multiresolution analysis technique.

2. Description of the Related Art

A signal can be viewed as composed of a smooth background and fluctuations or details on top of it. The distinction between the smooth part and the details is determined by the resolution. At a given resolution, a signal is approximated by ignoring all fluctuations below that scale. The resolution can be progressively increased; at each stage of the increase in resolution finer details being added to the coarser description, providing a successively better approximation to the signal. Eventually when the resolution goes to infinity, the exact signal is recovered. Multiresolution refers to the simultaneous presence of different resolutions.

Systems are available in the market, which enable users to play back an audio signal at a decelerated rate. The audio signals that are typically played back at decelerated rates can be a speech signal, a music recording and an audio data signal. However in none of the available systems does the pitch of the audio signal remain constant when it is played back at a decelerated rate.

Typically, when an audio signal is played back at a slower rate than the rate at which it is sampled, the pitch of the output audio signal is typically different than that of the original signal. Thus, sound quality deteriorates as it is played slower. There are no known audio systems that can handle this problem.

There may be several reasons for playing an audio signal at a rate that is slower than its sampling rate during audio signal capture or recording. However, the playback at a slower rate is often unpleasant if not a strange version of the original that sounds significantly different than the original.

### BRIEF DESCRIPTION OF THE DRAWINGS

For the present invention to be easily understood and readily practiced, preferred embodiments will now be described, for purposes of illustration and not limitation, in conjunction with the following figures:

FIG. 1 is a schematic block diagram illustrating one embodiment of a signal processing unit for playing back an audio signal at a decelerated rate with decelerated version of the audio signal having a pitch which is consistent with a pitch of the audio signal in a non-decelerated condition.

FIG. 2 is a schematic block diagram illustrating another embodiment of the signal processing unit for playing back an audio signal at a decelerated rate with decelerated version of the audio signal having a pitch which is consistent with a pitch of the audio signal in a non-decelerated condition.

FIG. 3 is a flowchart illustrating an example of a method for playing back an audio signal at a decelerated rate with decelerated version of the audio signal having a pitch which is consistent with a pitch of the audio signal in a non-decelerated condition.

### DETAILED DESCRIPTION OF THE PREFERRED EMBODIMENT(S)

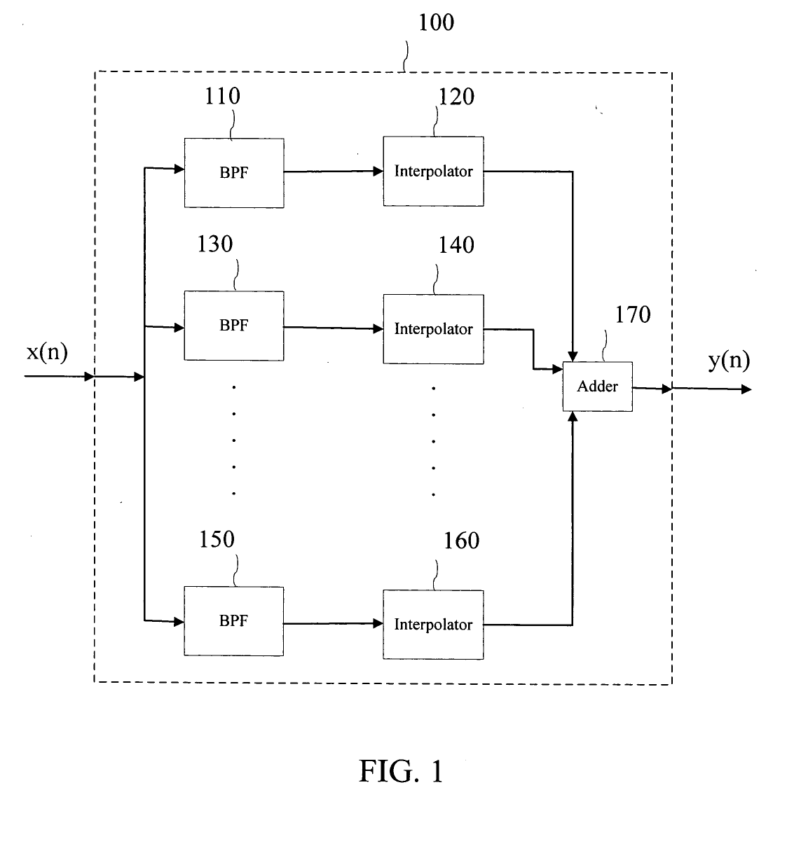

FIG. 1 is a schematic block diagram illustrating one embodiment of a signal processing unit for playing back an audio signal at a decelerated rate. x(n) is a first plurality of samples of the audio signal obtained by sampling the audio signal at a sampling frequency. The sampling frequency depends on a nature of the audio signal. The audio signal can be, for example, a speech signal, a pure music or an audio data signal which can be combination of both speech and music. The signal processing unit 100 processes the audio signal in time domain. The signal processing unit 100 has a plurality of bandpass filters, 110, 130, 150, a plurality of interpolators 120, 140, 160 and an adder 170. Each of the plurality of bandpass filters, 110, 130, 150 receive the first plurality of samples of the audio signal, x(n). The plurality of bandpass filters, 110, 130, 150 have different pass bands and different stop bands. Q factor of a bandpass filter is ratio of its center frequency to a width of the passband of the filter. The plurality of bandpass filters, 110, 130, 150 have a constant Q factor. The plurality of bandpass filters, 110, 130, 150 generate a second set of plurality of samples after passing x(n) through each of them. Constituents of the second set of plurality of samples are samples generated by each of the plurality of bandpass filters 110, 130, 150. The first plurality of samples of the audio signal, x(n), is a fixed number of samples, where the number of samples in x(n) is decided in the beginning depending upon a nature of the audio signal and the sampling frequency. The constituents of the second set of plurality of samples have each the same number of samples as in x(n). The plurality of interpolators 120, 140, 160 are communicatively coupled to outputs of the plurality of bandpass filters, 110, 130, 150. The plurality of bandpass filters and the plurality of interpolators correspond in number.

Interpolation is a process of estimating and inserting one or more values within two known values in a sequence of values. There are several known one dimensional interpolation techniques: nearest neighbor interpolation, linear interpolation, cosine interpolation, cubic spline interpolation are few of them. Nearest neighbor interpolation is fastest interpolation technique, but it gives worst result in terms of smoothness. Linear interpolation uses more memory and takes more execution time than nearest neighbor interpolation. In this technique, the known values or points are simply joined by straight line segments. Each segment (bounded by two data points) can be interpolated independently. In spite of being better than nearest neighbor interpolation, here slope of the straight line segments change at vertex points. Cosine interpolation gives a smoother interpolating function than linear interpolation. Cubic spline interpolation has longest relative execution time. It produces smoothest results of all the interpolation techniques. The plurality of interpolators 120, 140, 160 can employ any of known interpolation techniques depending upon availability of memory and execution time.

One of the plurality of interpolators, 120, 140, 160 is communicatively coupled to an output of only one of the plurality of bandpass filters, 110, 130, 150. The interpolator 120 is communicatively coupled to an output of the bandpass filter 110, the interpolator 140 is communicatively coupled to an output of the bandpass filter 130, the interpolator 160 is communicatively coupled to an output of the bandpass filter 150. The plurality of interpolators 120, 140, 160 generate a third set of plurality of samples. Samples generated by the bandpass filter 110, which is a constituent of the second set of plurality of samples, pass through the interpolator 120 and the interpolator 120 inserts at least one sample into the samples passing through it. Hence number of samples at an output of each of the plurality of interpolators 120, 140, 160 is more than the number of samples in x(n). The plurality of interpolators 120, 140, 160 employ different interpolation techniques. Interpolation technique employed by the interpolator 120 depends on the pass band and the stop band of the bandpass filter 110, that employed by the interpolator 140 depends on the pass band and the stop band of the bandpass filter 130, and so on. The adder 170 superimposes constituents of the third set of plurality of samples generated by the plurality of interpolators 120, 140, 160 on a sample by sample basis. Superimposition is carried out in time domain. The adder outputs a fourth plurality of samples, y(n). Each of the constituents of the third set of plurality of samples and y(n) have identical number of samples in them. Thus number of samples in y(n) is more than the number of samples in x(n). Hence on playing y(n), a decelerated version of the audio signal is obtained. The bandpass filters 110, 130, 150 and the interpolators 120, 140, 160 are so chosen that the decelerated version has a pitch which is consistent with a pitch obtained after playing x(n). Pitch of the decelerated version is consistent with the pitch of the audio signal in a non-decelerated condition.

In one embodiment of the present invention, x(n) is, for example, two hundred and fifty six number of samples of the audio signal and the audio signal is played back at a decelerated rate of two. The constituents of the second set of plurality of samples in the said embodiment are thus each two hundred and fifty six in number. The constituents of the third set of plurality of samples in the said embodiment will be each 256×2=512 (five hundred and twelve) number of samples. The plurality of interpolators 120, 140, 160 employ different interpolation techniques. The interpolation techniques employed by the plurality of interpolators in the said embodiment may be as follows. The interpolator 120 inserts one sample after every sample of the two hundred and fifity six samples passing through it. Thus the number of samples obtained at an output of the interpolator 120 is five hundred and twelve. The interpolator 140 inserts two samples after every two samples of the two hundred and fifty six samples passing through it. Hence the number of plurality of samples obtained at an output of the interpolator 140 is five hundred and twelve. Amplitudes of inserted samples depend on amplitudes of samples present at inputs of the plurality of interpolators. In the embodiment of the invention discussed above, the adder 170 superimposes five hundred and twelve samples generated by each of the plurality of interpolators 120, 140, 160. y(n) is thus five hundred and twelve samples available at an output of the signal processing unit 100. x(n) is two hundred and fifty six number of samples of the audio signal. Hence on playing y(n), a decelerated version of the audio signal is obtained.

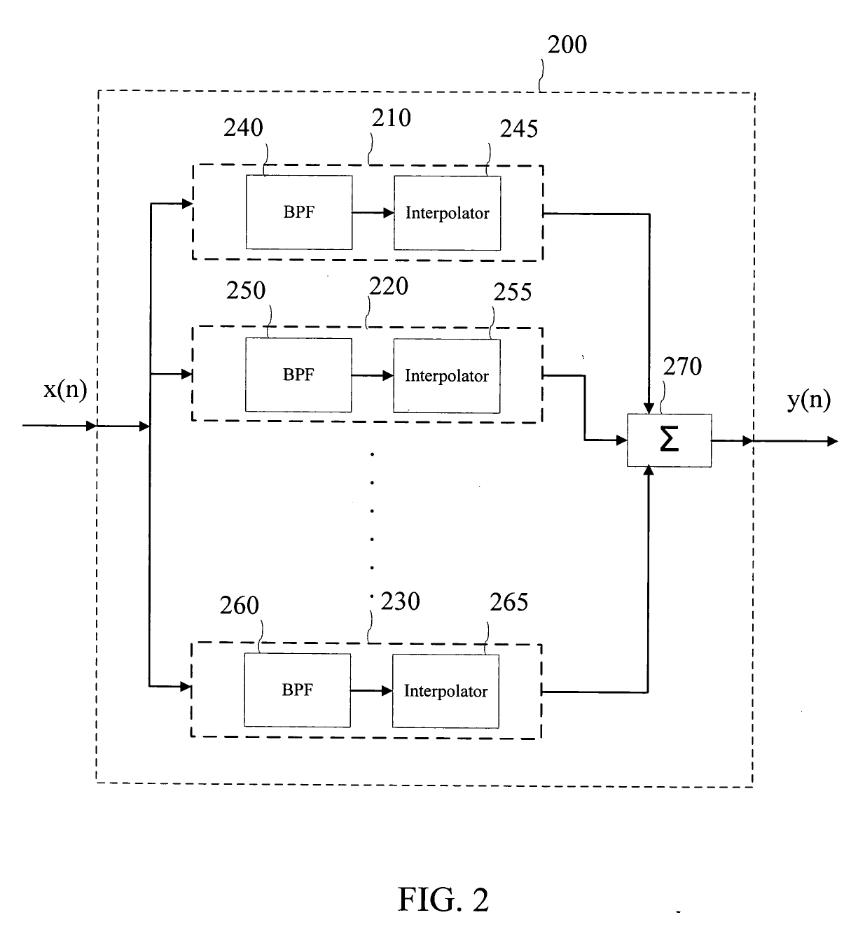

FIG. 2 is a schematic block diagram illustrating another embodiment of a signal processing unit for playing back an audio signal at a decelerated rate. The signal processing unit 200 has a plurality of subunits connected in parallel. There is at least a bandpass filter and an interpolator communicatively connected to the bandpass filter in each of the plurality of subunits 210, 220, 230. The subunit 210 has a bandpass filter 240 and an interpolator 245 communicatively connected to the bandpass filter 240. The subunit 220 has a bandpass filter 250 and an interpolator 255. The subunit 230 has a bandpass filter 260 and an interpolator 265. The bandpass filters 240, 250, 260 have different pass bands and a constant Q factor. The interpolators 245, 255, 265 employ different interpolation techniques. Interpolation technique employed in an interpolator depends at least on a pass band and a stop band of the bandpass filter to which it is communicatively connected. Interpolation technique employed by the interpolator 245 depends at least on a pass band and a stop band of the bandpass filter 240, interpolation technique employed by the interpolator 255 depends at least on a pass band and a stop band of the bandpass filter 250 and so on. x(n) is a first plurality of samples of the audio signal obtained by sampling the audio signal at a sampling frequency. The sampling frequency depends on a nature of the audio signal. The audio signal can be, for example, a speech signal, a pure music or an audio data signal which can be combination of both speech and music. The first plurality of samples of the audio signal is passed through each of the plurality of subunits. The pluralities of subunits generate a second set of plurality of samples after passing the first plurality of the samples of the audio signal through them. A number of the plurality of subunits 210, 220, 230 to be connected in parallel depends at least on the sampling frequency of the audio signal, the decelerated rate at which the audio signal is to be played back, the Q factor of the bandpass filters 240, 250, 260 and an interference introduced by the bandpass filters. The adder 270 superimposes constituents of the second set of plurality of samples on a sample by sample basis. The constituents of the second set of plurality of samples are samples generated by the plurality of subunits 210, 220, 230. Superimposing in time domain generates a third plurality of samples, y(n). Number of samples in y(n) is more than number of samples in x(n). When y(n) is played, it generates a decelerated version of the audio signal. Determination of how many of the plurality of subunits to be connected in parallel and selection of the bandpass filters 240, 250, 260 and the interpolators 245, 255, 265 are aimed at maintaining pitch of the decelerated version of the audio signal consistent with a pitch of the audio signal in a non-decelerated condition.

By way of example, an audio signal is to be played back at a decelerated rate of two. Suppose, x(n) is two hundred and fifty six number of samples of the audio signal. x(n) is passed through each of the plurality of subunits, 210, 220, 230. The plurality of subunits generate a second set of plurality of samples after passing x(n) through them. The constituents of the second set of plurality of samples in the present embodiment are each 256×2=512 number of samples. In other words, number of samples present at outputs of each of the plurality of subunits 210, 220, 230 is five hundred and twelve. Number of samples in y(n), output of the adder, is again five hundred and twelve in the present embodiment. On playing y(n), a two times decelerated version of the audio signal is obtained.

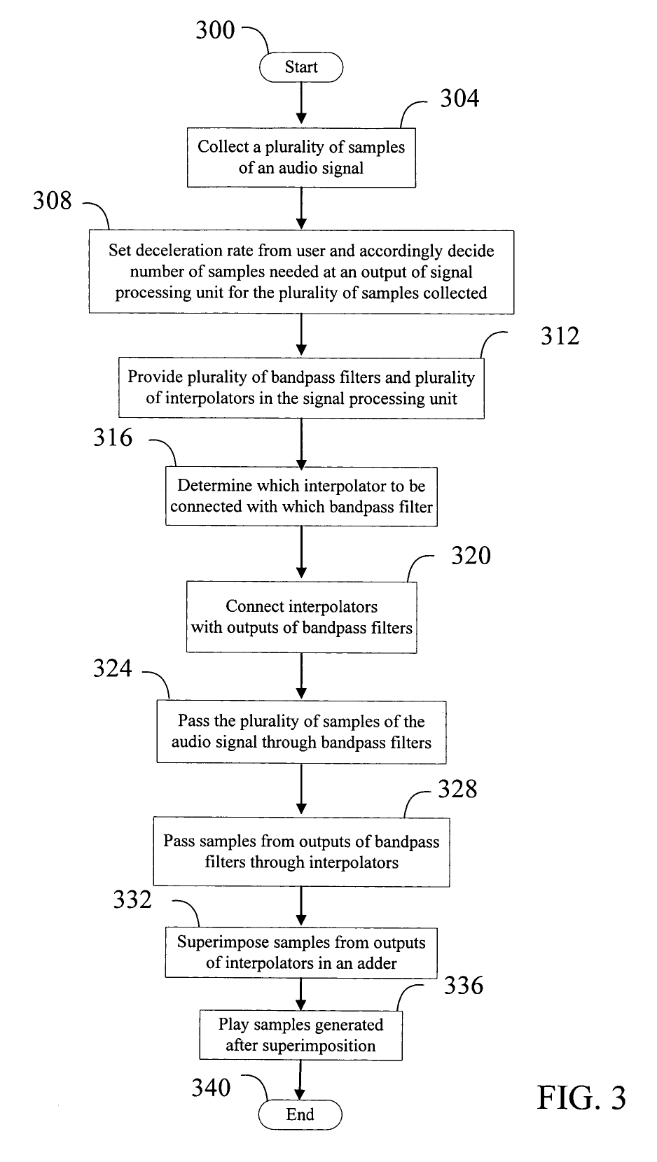

FIG. 3 is a flowchart illustrating an example of a method for playing back an audio signal at a decelerated rate by a signal processing unit. The process of playing an audio signal at a decreased rate starts at the block 300. Then, at block 304, the signal processing unit collects a first plurality of samples of the audio signal. The first plurality of samples of the audio signal are obtained by sampling the audio signal at a sampling frequency. The sampling frequency depends on a nature of the audio signal. The audio signal can be a speech signal, a pure music or an audio data signal which can be combination of both speech and music. In block 308, the signal processing unit sets an deceleration rate supplied by the user. It accordingly determines a number of samples to be generated at its output. The number of samples to be generated at output of the signal processing unit is number of collected samples of the audio signal multiplied by the deceleration rate.

The signal processing unit has a plurality of bandpass filters, a plurality of interpolators and an adder. In block 312, the plurality of bandpass filters and the plurality of interpolators are provided. The number of bandpass filters in the signal processing unit depends at least on the deceleration rate, the sampling frequency and an interference introduced by the plurality of bandpass filters. Q factor across the plurality of bandpass filters is kept constant. Pass bands and stop bands of the plurality of bandpass filters are designed to be different.

The plurality of interpolators and the plurality of the bandpass filters correspond in number. Interpolation technique employed by each of the plurality of interpolators is different. The interpolation technique employed in an interpolator can include inserting at least one sample into the plurality of samples passing through the interpolator. The determination of which of the plurality of bandpass filters is to be connected with which of the plurality of interpolators is done at the next block 316. Such a determination comprises inspecting a pass band and a stop band for each of the plurality of bandpass filters and inspecting the interpolation technique for each of the plurality of interpolators. The plurality of interpolators are communicatively connected with outputs of the plurality of bandpass filters in block 320.

Block 324 illustrates that the first plurality of samples of the audio signal collected at block 304 are passed through each of the plurality of bandpass filters. The plurality of bandpass filters generate a second set of plurality of samples. In the next block 328, samples generated at an output of each of the plurality of bandpass filters is passed through the corresponding interpolator to which the bandpass filter is connected. The plurality of interpolators generate a third set of plurality of samples. Constituents of the third set of plurality of samples are superimposed in step 332 on a sample by sample basis, giving rise to a fourth plurality of samples. The fourth plurality of samples are played in step 336 generating a decelerated version of the audio signal. Actions described in blocks 308, 312, 316, 320, 324, 328 and 332 ensure that pitch of the decelerated version of the audio signal is consistent with a pitch of a non-decelerated version of the audio signal. The process ends at block 340.

The above-discussed embodiments of the invention are discussed for illustrative purposes only. It would be understood to a person of skill in the art that other embodiments and other configurations are possible, while still maintaining the spirit and scope of the invention. For a proper determination of the scope of the present invention, reference should be made to the appended claims.

We claim:

1. A method of playing back an audio signal at a decelerated rate, said method comprising:
collecting a first plurality of samples of an initial audio signal at a signal processing unit;
passing the first plurality of samples of the initial audio signal through each of a plurality of bandpass filters, wherein the plurality of bandpass filters are configured to generate a second set of plurality of samples at their outputs;
providing a plurality of interpolators;
connecting the outputs of the plurality of bandpass filters with the plurality of interpolators, wherein the plurality of interpolators are configured to generate a third set of plurality of samples;
determining a number of a fourth plurality of samples to be generated at an output of the signal processing unit;
superimposing constituents of the third set of plurality of samples, said superimposing generates the fourth plurality of samples; and
playing the fourth plurality of samples as an audio signal.

2. The method according to claim 1, wherein the playing step comprises playing the decelerated audio signal with a pitch which is consistent with a pitch of the initial audio signal.

3. The method according to claim 1, wherein the passing the first plurality of samples comprises:
determining a number of the plurality of bandpass filters; and
calculating a pass band and a stop band for each of the plurality of bandpass filters.

4. The method according to claim 3, wherein the passing the first plurality of samples further comprises:
providing the plurality of bandpass filters with a constant Q factor.

5. The method according to claim 1, wherein providing the plurality of interpolators comprises:
selecting a number of the plurality of interpolators; and
determining an interpolation technique for each of the plurality of interpolators.

6. The method according to claim 5, wherein the interpolation technique comprises:
inserting at least one sample into the plurality of samples passing through an interpolator; and
determining an amplitude for each of the plurality of inserted samples, wherein the inserted samples together with original samples become a constituent of the third set of plurality of samples.

7. The method according to claim 1, wherein the connecting comprises:
communicatively connecting at least one bandpass filter of the plurality of bandpass filters with the plurality of interpolators; and
determining which of the plurality of bandpass filters to be communicatively connected with which of the plurality of interpolators.

8. The method according to claim 7, wherein determining which of the plurality of bandpass filters to be communicatively connected with which of the plurality of interpolators comprises:
inspecting the pass band and the stop band of each of the plurality of bandpass filters; and
inspecting the interpolation technique employed by each of the plurality of interpolators.

9. The method according to claim 1, wherein determining comprises:
multiplying a number of the first plurality of samples of the initial audio signal by the decelerated rate at which the audio signal is to be played back.

10. A signal processing unit for playing back an audio signal at a decelerated rate comprising:
a plurality of bandpass filters receiving a first plurality of samples of the audio signal, said plurality of bandpass filters configured to generate a second set of plurality of samples after passing the first plurality of samples of the audio signal through each of them;
a plurality of interpolators connected to at least one bandpass filter of the plurality of bandpass filters, said plurality of interpolators configured to generate a third set of plurality of samples; and
an adder configured to superimpose constituents of the third set of plurality of samples generated by the plurality of interpolators on a sample by sample basis,
wherein the adder outputs a fourth plurality of samples which when played generates a decelerated version of the audio signal having a pitch which is consistent with a pitch of the audio signal in a non-decelerated condition.

11. The signal processing unit according to claim 10, wherein:
the plurality of bandpass filters comprise different pass bands;
the plurality of bandpass filters comprise different stop bands; and
the plurality of bandpass filters have a constant Q factor.

12. The signal processing unit according to claim 10, wherein:
the plurality of interpolators are communicatively coupled to outputs of the plurality of bandpass filters;
the plurality of bandpass filters and the plurality of interpolators correspond in number; and
one of the plurality of interpolators is communicatively coupled to an output of only one of the plurality of bandpass filters.

13. The signal processing unit according to claim 10, wherein:
the plurality of interpolators employ different interpolation techniques.

14. The signal processing unit according to claim 13, wherein:
each of the plurality of interpolators inserts at least one sample into a plurality of samples passing through it; and
each of the plurality of interpolators sets amplitudes for inserted samples, wherein the inserted samples together with the plurality of samples become a constituent of the third set of plurality of samples.

15. The signal processing unit according to claim 12, wherein:
which of the plurality of interpolators to be communicatively coupled to the output of which of the plurality of bandpass filters is determined by inspecting the different pass bands and the different stop bands of the plurality of bandpass filters and inspecting the different interpolation techniques employed by the plurality of interpolators.

16. A method of playing back an audio signal at a decelerated rate, said method comprising:
providing a plurality of subunits connected in parallel;
providing at least a bandpass filter and an interpolator in each of the plurality of subunits;
passing a first plurality of samples of the audio signal through the plurality of subunits, wherein the plurality of subunits are configured to generate a second set of plurality of samples after passing the first plurality of the audio signal through them; and
superimposing constituents of the second set of plurality of samples, said superimposing generating a third plurality of samples,
wherein playing the third plurality of samples generates a decelerated version of the audio signal having a pitch which is consistent with a pitch of the audio signal in a non-decelerated condition.

17. The method according to claim 16, wherein providing the plurality of subunits comprises:
determining a pass band and a stop band for the bandpass filter in each of the plurality of subunits, wherein pass bands and stop bands across the plurality of subunits are different;
maintaining Q factors of bandpass filters constant across the plurality of subunits; and
determining different interpolation techniques for interpolators in the plurality of subunits.

18. The method according to claim 17, wherein:
interpolation technique employed in an interpolator depends at least on the pass band and the stop band of the bandpass filter to which it is communicatively connected.

19. The method according to claim 16, wherein:
determining the number of the plurality of subunits to be connected in parallel depends at least on a sampling frequency of the audio signal, the decelerated rate at which the audio signal is to be played back, Q factor of bandpass filters provided in the plurality of subunits and an interference introduced by them.

20. The method according to claim 16, wherein:
the audio signal is at least one of a speech signal, a pure music or an audio signal which comprises of both speech and music signal.
